(19) United States
(12) Patent Application Publication
(10) Pub. No.: US 2021/0302025 A1
(43) Pub. Date: Sep. 30, 2021

(54) MAGNETIC INDUCTION ASSEMBLY FOR SURFACE HEATING

(71) Applicant: Heat X, LLC, Auburn Hills, MI (US)

(72) Inventor: Miguel A. Linares, Bloomfield Hills, MI (US)

(21) Appl. No.: 17/218,303

(22) Filed: Mar. 31, 2021

Related U.S. Application Data
(60) Provisional application No. 63/022,002, filed on May 8, 2020.
(60) Provisional application No. 63/002,756, filed on Mar. 31, 2020.

(51) Int. Cl. F24C 7/00; H05B 6/10; H05B 3/74; H05B 3/28; H05B 1/02; H05B 6/06; F24C 15/00

(52) U.S. Cl. CPC F24C 7/006; H05B 6/109; H05B 6/108; F24C 15/006; H05B 3/283; H05B 1/0258; H05B 6/062; H05B 3/74

(57) ABSTRACT

An assembly for magnetic induction or magnetocaloric heating of a cooktop surface. One or more magnetic/electromagnetic plates are rotated by a motor or other rotary inducing input in proximity to a stationary supported magnetocaloric heating material conductive plate. Joule heating and eddy currents are generated through oscillating of magnetic fields at a given frequency when magnets/electromagnets rotate, and which is conducted through the magnetocaloric heating material via conduction and emanates from an exposed surface thereof. Conventional heating elements, such as resistor coils, are integrated into the magnetocaloric cooktop material in order to provide fast initial heat up of the materials and can be de-powered once inductive heating of the magnetocaloric material achieves desired performance levels. The housing interior can be sealed and contain a volume of any type of thermal fluid oil, lubricant or refrigerant or any other fluid with high specific heat capacity and high boiling point for providing any heat transfer properties.

### CROSS REFERENCE TO RELATED APPLICATIONS

The present application claim the priority of U.S. Ser. No. 63/002,756 filed Mar. 31, 2020 as well as U.S. Ser. No. 63/022,002 filed May 8, 2020.

### FIELD OF THE INVENTION

The present invention relates generally to magnetic induction or magnetocaloric heating assemblies. More specifically, the present invention discloses a magnetic induction or magnetocaloric assembly for providing heating of a cooktop surface, such as associated with a range, stove top or the like. Joule heating and eddy currents are generated in an underside of the assembly with one or more magnetic plates being rotated by a motor or other rotary input in proximity to a stationary supported magnetocaloric heating material conductive plate. Inductive heating is transferred through the magnetocaloric heating material conductive plate via conduction and emanates from an exposed, typically cooktop, surface thereof. Conventional heating elements, such as resistor coils, can be integrated into the magnetocaloric heating material conductive plate or cooktop in order to provide a faster initial heat up of the materials. Such conventional elements may be de-powered or turned off after a few minutes once inductive heating of the magnetocaloric material achieves desired parameters.

### BACKGROUND OF THE INVENTION

The phenomena of magnetic induction heating is well known in the prior art by which heat is generated in an electrically conductive object by the generation of eddy currents, also called Joule heating. The typical induction heater includes an electronic oscillator which passes a high frequency alternating current through an electromagnet. The eddy currents flowing through the resistance of a conductive metal placed in proximity to the magnet/electromagnet result in the creation of heat. Put another way, the eddy currents result in a high-frequency oscillating magnetic field which causes the magnet's polarity to switch back and forth at a high-enough rate to produce heat as byproduct of friction.

One known example of a prior art induction heating system is taught by the electromagnetic induction air heater of Garza, US 2011/0215089, which includes a conductive element, a driver coupled to the conductive element, an induction element positioned close to the conductive element, and a power supply coupled to the induction element and the driver. Specifically, the driver applies an angular velocity to the rotate the conductive element around a rotational axis. The power supply provides electric current to the induction element to generate a magnetic field about the induction element such that the conductive element heats as it rotates within the magnetic field to transfer heat to warm the cold fluid flow streams. The fluid flow streams are circulated about the surface of the conductive element and directed by the moving conductive element to generate warm fluid flow streams from the conductive element.

Also referenced is the centrifugal magnetic heating device of Hsu 2013/0062340 which teaches a power receiving mechanism and a heat generator. The power receiving mechanism further includes a vane set and a transmission module. The heat generator connected with the transmission module further includes a centrifugal mechanism connected to the transmission module, a plurality of bases furnished on the centrifugal mechanism, a plurality of magnets furnished on the bases individually, and at least one conductive member corresponding in positions to the magnets. The vane set is driven by nature flows so as to drives the bases synchronically with the magnets through the transmission module, such that the magnets can rotate relative to the conductive member and thereby cause the conductive member to generate heat.

Induction heating type apparatuses are also known which are integrated into a cooktop application and include the assembly of US 2020/0072472 to Kim. The cooktop includes a case, a cover plate coupled to an upper end of the case and including an upper plate configured to seat an object on an upper surface of the upper plate. A working coil disposed in the case is configured to heat the object. A thin film is attached on the upper plate and a thermal insulating member is disposed vertically between a lower surface of the upper plate and the working coil.

Nam, US 2019/0289678 teaches a method of operating an induction cooktop appliance including supplying a power signal to an induction heating element of the appliance in response to a request received via a user input of the appliance. Other references of note include the induction stirring apparatus for a cooktop disclosed in US 2017/0202059 of Stoufer.

### SUMMARY OF THE PRESENT INVENTION

The present invention discloses a magnetic induction or magnetocaloric assembly for providing heating of a cooktop surface, such as associated with a range, stove top or the like. A housing supports the cooktop surface and includes each of a fluid inlet and outlet. A magnetocaloric heating material is incorporated into the cooktop surface.

Any of a magnet or an array of magnets or electromagnets are embedded into or attached to a rotatable disk or plate supported in underside proximity to the magnetocaloric heating material conductive plate through an underside of the assembly in communication with one or more magnetic plates which are rotated by a motor or other rotary inducing input in proximity to the stationary supported magnetocaloric heating material conductive plate. Without limitation, the magnets can be substituted by electromagnets within the scope of the invention. Inductive heating of the magnetocaloric heating material conductive plate is transferred via conduction and emanates from an exposed, typically cooktop, surface thereof.

Conventional heating elements, such as resistor coils, can be integrated into the magnetocaloric cooktop material in order to provide a faster initial heat up of the materials. Such conventional elements can operate simultaneously or typically being de-powered or turned off after a few minutes once inductive heating of the magnetocaloric material achieves desired parameters. Other features include a heat insulating material surrounding said magnetocaloric heating material conductive plate. The cooktop surface may further include a glass overlaying said heat insulating material, apertures in the glass seating an outer annular edge of the magnetocaloric heating material.

A fluid inlet may incorporate a plurality of intake openings configured along an underside of the housing. A motor or other rotary inducing input is supported within the housing, with a shaft extending from the motor or other rotary inducing input to a rotatable and insulated disk embedding the magnet(s)/electromagnet(s). These further include either of a unitary ring shape or a plurality of individual and circumferentially spaced individual portions arranged about a perimeter of the magnet/electromagnet carrier or magnetic disk.

Other features include the motor or other rotary inducing input having an outer casing, a plurality of pass-through apertures being configured through the casing in communication with the intake openings. A skirt is secured to an underside of the rotatable disk for redirecting fluid flow radially outwardly and downwardly through an outer annular underside configuration of the fluid outlet defined in the housing.

Other features include the magnetocaloric material conductive plates further including any metal or alloy, ceramic or any metal-ceramic composite material or graphite or combination of such materials. Other pattern designs, such as using multiple materials, can be incorporated into the magnetocaloric heating material conductive plates.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 a perspective view of a magnetic induction or magnetocaloric assembly for surface heating according to a non-limiting embodiment of the present invention;

FIG. 2 is an enlarged and cutaway view of the assembly of FIG. 1 and better illustrating the motor or other rotary inducing input, rotating magnet array and magnetocaloric heating material conductive plate along with the directional patterns of the airflow for thermally conditioning electric motor within the specified operating temperatures and also depicting the conventional heating elements, such as resistor coils, which can be integrated into the magnetocaloric cooktop material in order to provide fast initial heat up of the materials;

FIG. 2A is an enlarged cutaway view of an alternate variant to that shown in FIG. 2 and in which a sealed assembly substitutes for the ventilated configuration and within which internally circulates any type of oil, lubricant/refrigerant or any other fluid with high specific heat capacity and high boiling point for conducting or redirecting heat;

FIG. 3 is a perspective illustration of a surface heating assembly not limited to a cooktop according to one non-limiting embodiment of the present inventions;

FIG. 4 is a cutaway view of the assembly of FIG. 3, such as which can include cogeneration capabilities, and depicting an internal mounted electric motor according to one variant in which the rotor component of the motor (such rotating around the fixed stator) also functions as a magnet/electromagnet carrier or magnetic disk, in this instance rotating one or more magnets/electromagnets positioned relative to an underside layer of the cooktop which can include any magnetic flux responsive material;

FIG. 5 is a further cutaway of the surface heating assembly in FIG. 4, which again can include cogeneration capabilities, and illustrating the inner components of the motor including the magnet supporting plate which includes a built-in fan for assisting in cooling the motor, as well as the incorporation of electronically controlled current carrying coils for rotating the magnets according to a desired phase arrangement and in turn for generating the magnetic flux for heating up the magnetocaloric heating material conductive plate or cooktop surface;

FIG. 6 is an illustration of an alternate variant of surface heating assembly to that depicted in FIG. 3 and showing an induction control subassembly with internal coils and which, upon passing a current therethrough, creates an oscillating magnetic field for generating the eddy currents flowing through the resistance of the magnetocaloric heating material conductive plate or cooktop surface which can be constructed of any electrically or electromagnetic induction responsive material;

FIG. 7 is a sectional illustration depicting an arrangement of vertical inner rotor supported magnets/electromagnets associated with a further variant of a surface heating assembly;

FIG. 8 is a corresponding sectional illustration to that shown in FIG. 7 and depicting an arrangement of vertical arrayed outer rotor supported magnets/electromagnets associated with a further variant of a surface heating assembly;

FIG. 9 is a corresponding sectional illustration combining that shown in each of FIGS. 7 and 8 and depicting both vertical arrayed outer and inner rotor supported magnets/electromagnets associated with a yet further variant of a surface heating assembly;

FIGS. 10-10K provide a series of perspective and partial cutaway illustrations of varying conductive plate patterns which can be incorporated into the present invention;

FIGS. 11-11K provide a series of illustrations of varying magnetic plate, pan or ring configurations according to other and additional variants of the present inventions;

FIGS. 12-12G depict varying examples of conductive plate configurations including varying compositions of coating, magnetic flux shielding, magnetic permeable materials, conductive materials and/or insulating materials;

FIGS. 13-13D depict variations of cooktop located conductive plate pockets filled with different types of materials which can include varying patterns of materials, bi-materials or multi-materials designs, such materials including any of metals or alloys, ceramics or any metal ceramic composite, polymers or composites; and

FIGS. 14-14B depict additional configurations of cooktop located conductive plate pockets filled with different types of materials which can include varying patterns of materials, bi-materials or multi-materials designs, such materials including any of metals or alloys, ceramics or any metal ceramic composite, polymers or composites.

### DETAILED DESCRIPTION OF THE PREFERRED EMBODIMENTS

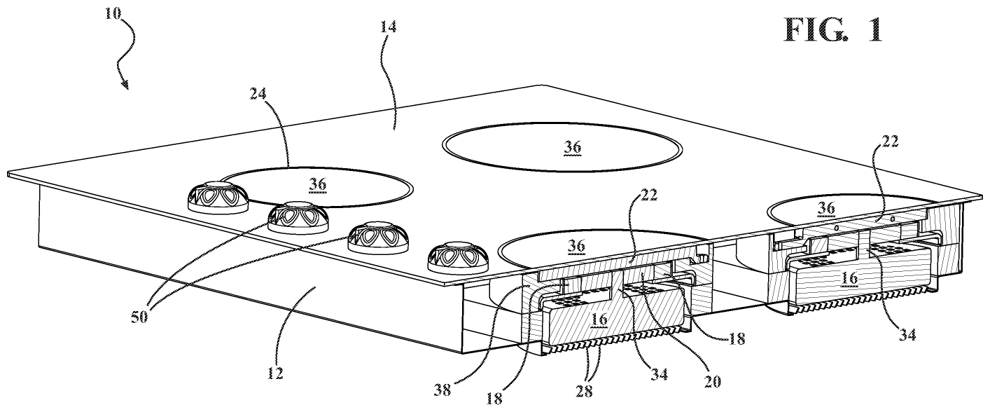

With reference to the attached illustrations, the present invention discloses an assembly for magnetic induction or magnetocaloric heating of a cooktop surface. FIG. 1 a perspective view of a magnetic induction or magnetocaloric assembly for surface heating according to a non-limiting embodiment of the present invention and includes such as a three dimensional rectangular housing 12 which may include a surface material which can have any of a glass or other suitable cooktop surface 14 not limited to ceramics and composites thereof, and which can also exhibit insulating properties at given locations.

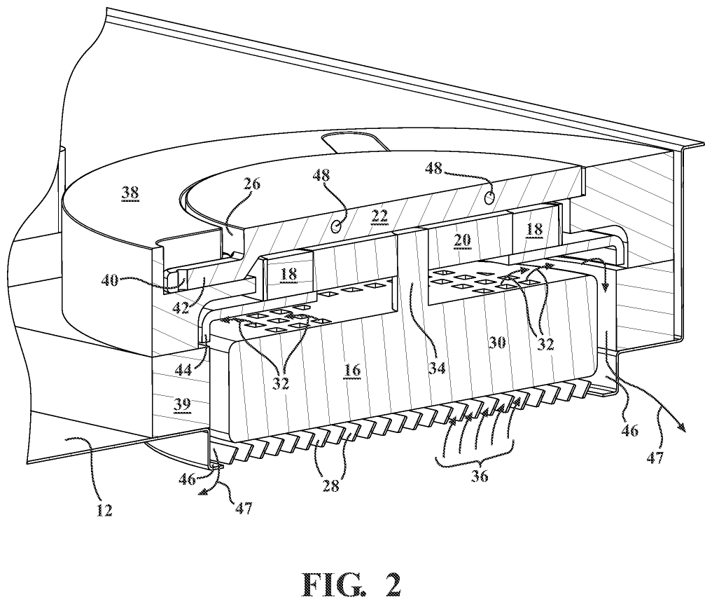

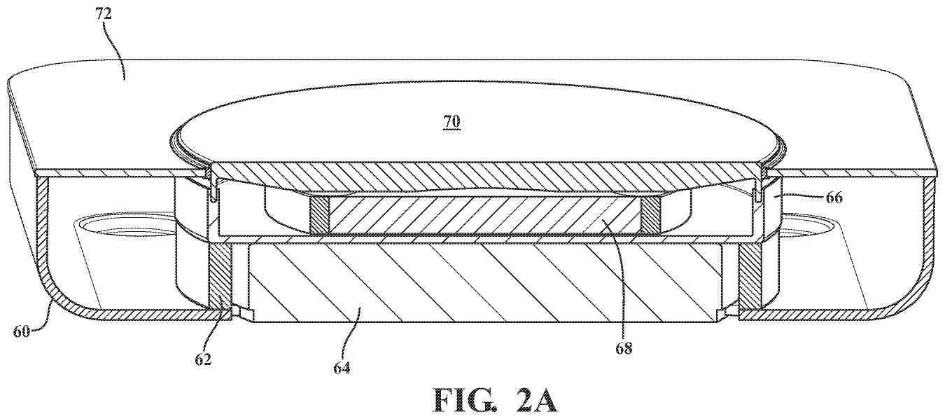

In combination, FIG. 2 illustrates an enlarged and cutaway view of the assembly of FIG. 1 (with the glass or ceramic cooktop removed) and better illustrating, in combination, each of a motor 16, a rotating magnet array (see magnets 18 embedded into or attached to a magnet/electromagnet carrier or magnetic disk 20 according to any type of array or pattern) and a thermally conductive material, such further exhibited by magnetocaloric heating material conductive disks 22, which can include any magnetocaloric heating material conductive plate incorporated into the assembly in underside proximity to the cooktop surface 14. As shown, the magnetocaloric heating conductive plate is provided in plural form within the overall cooktop surface of FIG. 1, four of which are shown in FIG. 1 at 36, and which are distributed across the cooktop surface 14 so that cutout portions (see perimeter defined outlines at 24 in FIG. 1) of the glass cooktop 14 which align with outer annular profiles (at 26 as best shown in FIG. 2) exhibited by each of the underside positioned magnetocaloric heating material conductive disk shaped portions 22.

A fluid inlet is configured in a bottom of the housing 12 and includes a plurality of intake openings which are defined between an array of spaced apart and (optionally angled) dividers 28 which communicate fluid flow via intake pathways depicted in FIG. 2 at 30. The motor 16 (such as an electric motor or other rotary inducing input) can include an outer casing exhibiting the plurality of intake pathways 30 in the form of pass-through apertures for communicating the intake flow (see further as depicted by directional arrows 32).

A shaft 34 extends upwardly from the motor 16 and mounts the magnet/electromagnet carrier or magnetic disk 20 with magnet array 18 (also termed a magnetic plate) in underside proximity to the conductive/magnetocaloric material 22. Upon rotating the magnet supporting disk or plate 20, the fluid flow is drawn into the housing 12 through the inlet and in proximity to the magnet supporting plates 20 which, upon rotation in close underside proximity to the magnetocaloric heating materials conductive plate 22. Joule heating and eddy currents are generated through oscillating of magnetic fields at a given frequency when the magnets/electromagnets are rotated. The heat then emanates conductively from the cooktop surface (see also again conductive surfacing layer portions 36 in FIG. 1 which can overlay or form a portion of the magnetocaloric heating material conductive plate 22 and which exhibits suitable conductive properties for conducting heat to a pot, pan, skillet or the like placed upon the heating conductive plate 22).

As again shown in FIG. 2, a heat insulating material 38 surrounds each of the magnetocaloric heating materials conductive plate 22 and is located upon a supporting base layer 39 within the housing 12. As best shown in cross sectional cutaway in FIG. 2, the base layer 39 is hollowed centrally to seat the motor 16. The insulating material 38 further includes an expanded cutout portion 40 for seating an annular projecting portion 42 of the magnetocaloric heating material conductive plate 22, this in order to securely and position-ally support the magnetocaloric heating material conductive plate 22 stationary above the rotating magnet/electromagnet carrier or magnetic plate 20 and motor 16.

The magnet 18 can further include either of a continuous ring shape integrated into the rotatable magnet/electromagnet carrier or magnetic disk 20 or (as further described in succeeding variants) can be provided as a plurality of individual and circumferentially spaced segmented portions arranged about a perimeter of said insulated disk. A skirt 44 is secured to an underside of the rotatable magnet/electromagnet carrier or magnetic disk 20 for redirecting fluid or air flow radially outwardly (see again arrows 32) and downwardly through an outer annular underside configuration, further at 46 through which outward arrows 47 extend, of the fluid outlet defined in the housing 12.

Other features include the provision of one or more conventional heating elements, this including such as wire resistor coils or the like as shown at 48, which can be integrated into the magnetocaloric heating material conductive plate or cooktop 22, this as best shown in the cutaway of FIG. 2, for assisting initial heat up of the magnetocaloric material and until adequate magnetic induction heating results from inter-rotation of the magnets 18 and magnet/electromagnet carrier or magnetic plate 20 relative to the overlaying magnetocaloric heating material conductive plate 22. Also shown are knob controls 50 (see FIG. 1) which can be calibrated with the separate temperature controllers (not shown) to achieve a desired heat level for each given subassembly. The controls can be designed to vary the speed of the motors or other rotary inducting inputs, and thereby the rate/level/speed of the inductive heating generated at each magnetocaloric heating material conductive plate.

The controller can provide also the option for deactivating the conventional heating element after a few minutes, once magnetic induction or magnetocaloric heating of the magnetocaloric heating material conductive plate achieves desired performance parameters or to accelerate the heating process to reach the desired temperatures faster. As will be further described in succeeding illustrations, the magnetocaloric materials can further include suitable metal or alloy, ceramic or any metal-ceramic composite material or graphite or any combination of such materials.

FIG. 2A is an enlarged cutaway view of an alternate variant to that shown in FIG. 2 and in which a sealed assembly substitutes for the ventilated configuration and within which internally circulates any type of oil, lubricant/refrigerant or any other fluid with high specific heat capacity and high boiling point for conducting or redirecting heat. The assembly includes a housing 60 similarly having a base layer 62 within which is supported a motor 64. A re-designed insulating material 66 is supported atop the base layer. A magnet/electromagnet supporting plate 68 is contained within a hollow tray interior of the insulating material 66. A magnetocaloric heating material conductive plate 70 is incorporated into a lid 72 of the housing 60. The sealed housing can contain a volume of any type of thermal fluid including any oil, lubricant or refrigerant or any other fluid with high specific heat capacity and high boiling point which can provide any heat transfer properties in lieu of the fluid flow patterns 36 and 47 in the variant of FIG. 2.

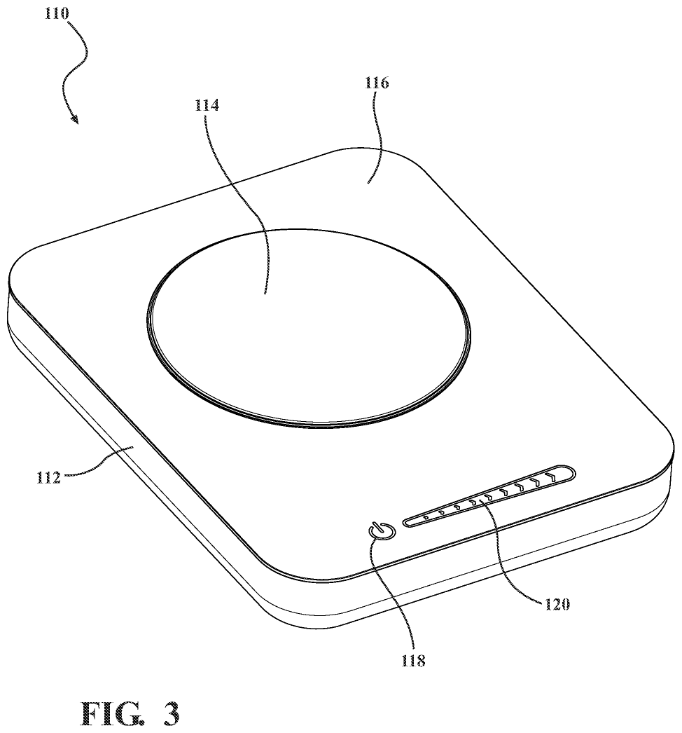

Referring to FIG. 3, a perspective illustration is generally shown at 110 of a portable surface heating assembly, again not limited to a cooktop variant, and according to a further non-limiting embodiment of the present inventions. The cooktop can include a body 112 exhibiting a compact three dimensional rectangular profile having a surface cooktop area 114 which can include any of a ceramic or other non-stick conductive surface coating. A glass overlay 116 can be provided over the cooktop area 114 (and which can include a solid overlay sheet or a boundary defining portion which seats the cooktop area 114). Also shown is a capacitive touch (or other sensor enabled) on/off button 118 as well as a temperature range control 120.

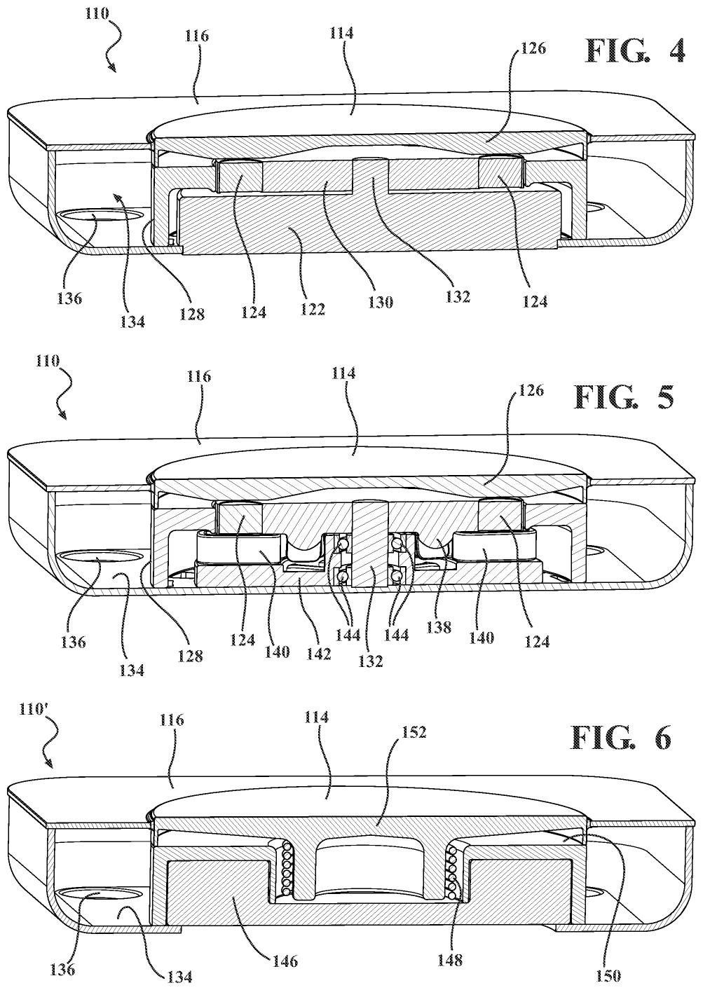

FIG. 4 is a cutaway view of the assembly of FIG. 3, and further depicts an internal mounted electric motor 122 according to one non-limiting variant. The rotor component (see as depicted at 130) of the motor rotates around a fixed stator and also functions as an inductive or magnetocaloric heating material conductive plate, in this instance rotating one or more upper supported magnets/electromagnets 124 positioned relative to an underside layer of the cooktop 126 which can include any magnetic flux responsive material. The motor can be encased within an outer annular insulating material 128, the combination rotor/fan rotating plate or layer 130 being supported by a central rotating shaft 132 for rotatably driving the outer peripheral located magnets/electromagnets 124. An interior cavity 134 is shown in the FIG. 4 cutaway extending around the insulating material 128, with one or more apertures 136 configured in the bottom of the cooktop body and providing for any desired ventilation or cooling of the motor 122 and other interior components of the assembly.

Proceeding to FIG. 5, a further cutaway is shown of the surface heating assembly in FIG. 4 (which can again incorporate additional cogeneration capabilities as described in reference to FIG. 4) and better illustrating the inner components of the motor and which can include a built-in fan 138 incorporating a reconfiguration of a rotating rotor/magnet supporting plate containing the magnets/electromagnets 124, and for assisting in cooling the motor. Other features include electronically controlled coils 140 positioned opposing to the magnets/electromagnets 124 and which receive a current flow in a desired phased arrangement in order to rotate combination plate and heat distributing fan element 138 incorporating the magnets/electromagnets, this in turn generating the magnetic flux for heating up the magnetically responsive magnetocaloric heating material conductive plate or cooktop. As further shown, a base stator component 142 of the motor is supported upon a bottom of the cooktop body for supporting the subassemblies of coil windings 140. Bearings 144 are provided for supporting the motor driven shaft 132 during its rotation of the magnet/electromagnet supporting rotor plate or component 138.

Proceeding to FIG. 6, an illustration is provided generally at 110′ of an alternate variant of surface heating assembly to that depicted at 110 in FIG. 3, in this instance showing an induction control subassembly 146. An arrangement of internal induction coils 148 are shown in a generally arcuate and annular arranged fashion and which are radially positioned between an outer radial located insulating outer portion 150 (as opposed to that depicted at 128 in FIG. 5) and an inner and upward projecting cooktop layer 152, this further constructed of any electrically or electromagnetically induction responsive material.

The induction heating variant of FIG. 6 can operate without a motor or other rotating component and, upon passing a current through the coils, creates an oscillating magnetic field for generating eddy currents flowing through the conductive plate or the cooktop. This can also include generating eddy currents in a pot or other suitable metal conducting vessel placed upon the cooktop surface, such that the resistance caused thereby creates the necessary heating effect. All other features are similar in comparison to the cooktop variant 110 as shown in FIGS. 3-5.

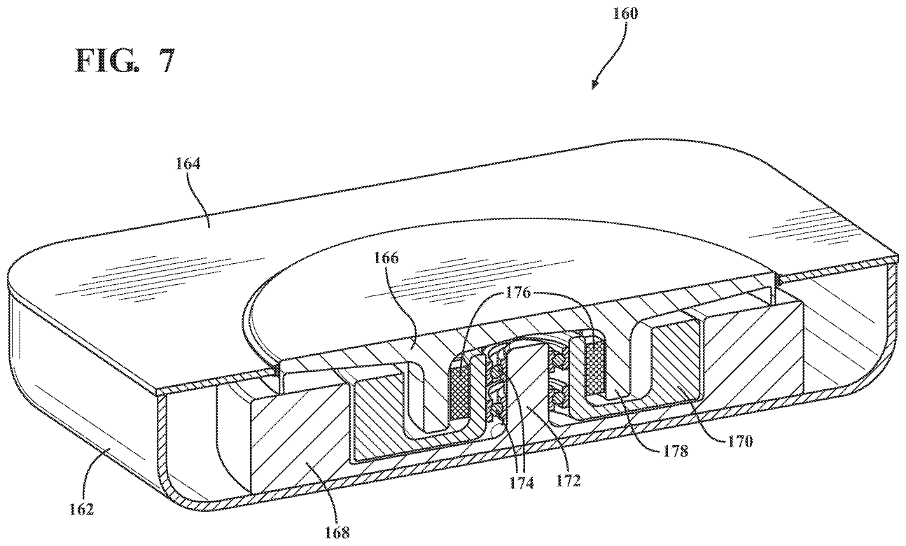

Proceeding now to FIG. 7, a sectional illustration is generally shown at 160 of a further variant of surface heating assembly, again including each of a housing 162 and lid 164 integrating a cooktop layer 166 constructed of any electrically or electromagnetically induction responsive material. A stator component 168 is depicted supported within the housing interior and upon which is seated a rotor 170. A central upward projection 172 of the stator 168 includes a pair of bearings 174 for guiding the rotating motion of the rotor 170. An arrangement of vertical magnets/electromagnets are depicted at 176 arranged upon an inner and exteriorly facing location of the rotor 170, this opposing an annular downward projecting portion 178 of the cooktop layer 166 and such that, and upon rotation of the rotor, heating of the cooktop magnetocaloric material results.

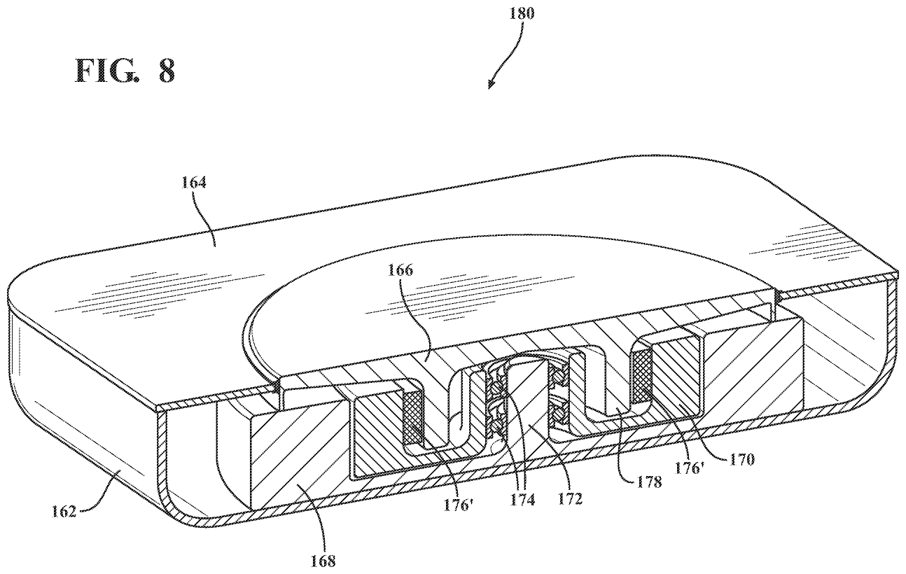

FIG. 8 is a corresponding sectional illustration to that shown in FIG. 7 of a surface heating assembly, generally at 180, in which repetitive features are identically numbered. FIG. 8 further depicts an arrangement of vertical arrayed magnets/electromagnets (see at 176′ as compared to at 176 in FIG. 8) arranged upon an outer and inward facing location of the rotor 170, again opposing the downward cooktop portion 178 so that the magnets/electromagnets 176′ are positioned externally of the downward cooktop portion 178 according to a further variant of a surface heating assembly.

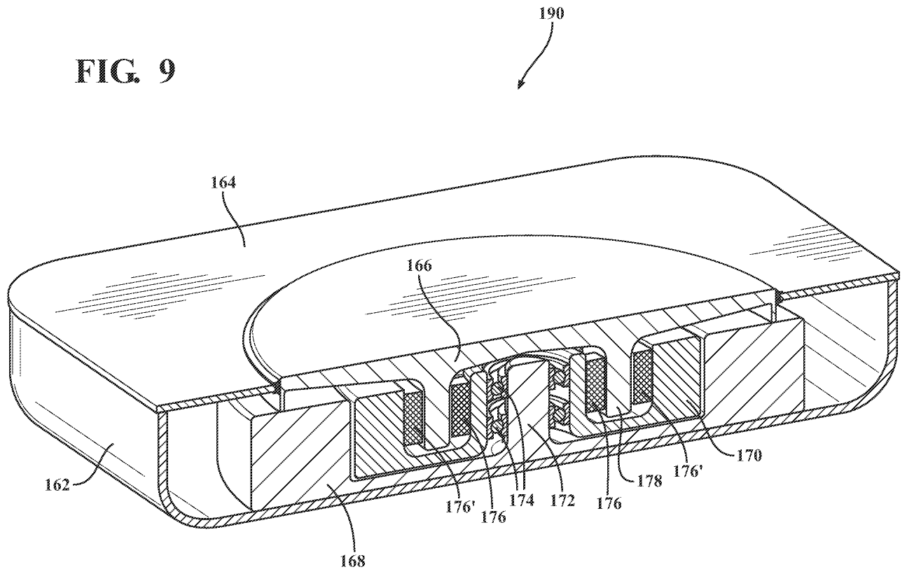

FIG. 9 is a corresponding sectional illustration, combining that shown in each of FIGS. 7 and 8, as generally referenced at 190 and depicting a double vertical array of both outer (again 176′) and inner (176) rotor supported magnets/electromagnets associated with a yet further variant of a surface heating assembly. By this arrangement, the magnets/electromagnets oppose both of inner and outer facing annular surfaces of the annular downward projection 178 of the magnetocaloric cooktop 166 to provide enhanced heating upon actuation of the rotor.

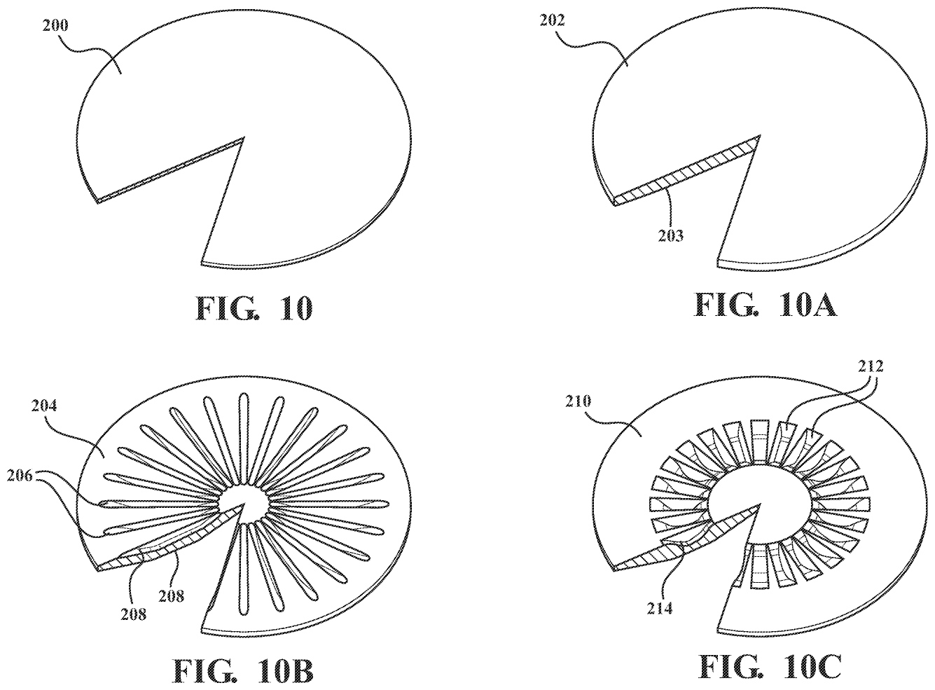

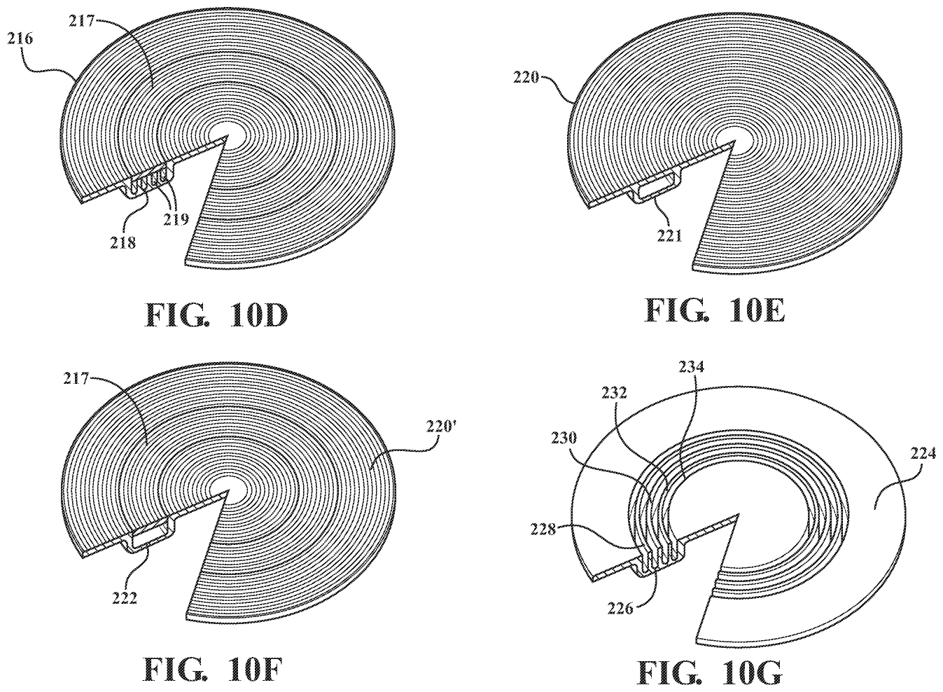

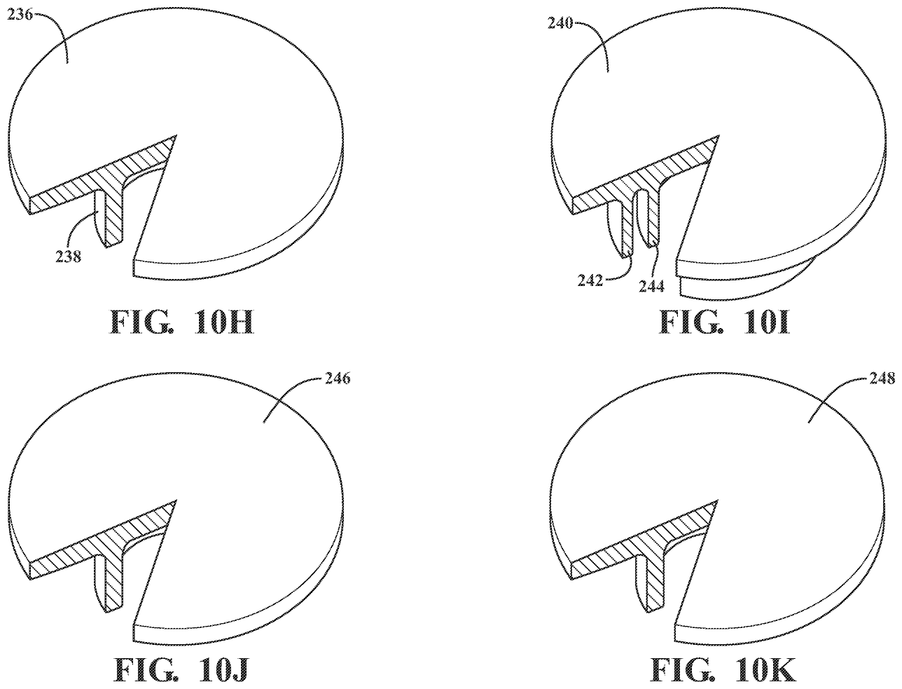

FIGS. 10-10K provide a series of perspective and partial (pie shaped) cutaway illustrations of varying magnetocaloric heating material conductive plates or cooktop plates with different patterns which can be incorporated into the present invention according to any of the described embodiments. In each instance, a selected design provides for a desired heat transfer/distribution profile, along with providing lower magnetic friction and, where appropriate, controlled magnetic flux overflow onto the top cooktop surface.

FIG. 10 presents a first example of a conductive cooktop incorporated plate at 200. FIG. 10A presents a similar plate design at 202 which can include a thicker composition relative to that shown at 200 and as depicted in sectional cutout. As further shown in FIG. 10A, a tapered underside 203 provides for improved heat distribution.

FIG. 10B depicts a further plate 204 incorporating a plurality of outward radial arranged slots 206, with each exhibiting a given depth defining profile 208 and in which the bottom surface of the plates can be tapered or sloped (at 209). A similar plate is shown at 210 in FIG. 10C and includes a redesigned plurality of circumferentially arranged and radial directed slots or notches 212. Each of the slots/notches 212 further exhibits an arcuate base surface (see as depicted at 214 in cutout), with the plates 204 and 210 as shown each further having a tapered cross sectional profile similar to FIG. 10B with narrowed outer and central locations and a widened intermediate radial portion. The radial recess profiles and patterns in FIGS. 10B/10C also provide for improved heat transfer along with lower magnetic friction.

FIG. 10D depicts a further plate example 216 which, similar to that shown at 200 and 202, exhibits a thin disk shape having a plurality of coaxial surface or ribs ribbed etchings configured in an upper surface and which can enhance heat transfer of the magnetocaloric material. The plate 216 further exhibits any number of underside integrated pockets or individual enclosures, these also termed risers or podiums and as shown at 218. Also included is a halo shaped drop in lid or attachment 217 which can likewise include an etched upper surface and can be remove-ably attached to cover the riser or podium 218 (such as which can also include a continuous annular shape). Also shown are lower magnetic friction patterns 219 containing any of a variety of material arrays which can be installed or reconfigured upon removal of the upper halo 217, and as will further described in succeeding illustrations.

FIG. 10E depicts a plate 220 similar to that shown in FIG. 10D at 216, again including coaxial surface etched lines, and again including a podium or riser portion 221 (also synonymously referenced as an underside pocket of the plate). This is further depicted having a hollow interior shape which can be a single annular extending component or which can be provided as individual and circumferentially spaced portions. In each instance, the pocket or pockets can be filled with any suitable materials including varying patterns of materials, bi-materials, or multi-materials designs, such materials further including any of metals or alloys, ceramics or any metal ceramic composite, polymers or composites.

FIG. 10F depicts a slight variant 220′ of the plate shown in FIG. 10E and again references an etched or ribbed upper pattern of the magnetocaloric plate which can increase surface area for enhanced heat transfer. The attachable halo shaped lid portion 217 is again shown, as is a reconfiguration of the pocket shaped riser or podium at 222 and, similar to as shown at 221 in FIG. 10E, can be hollow or can again be filled with any suitable materials including varying patterns of materials, bi-materials, or multi-materials designs, such materials further including any of metals or alloys, ceramics or any metal ceramic composite, polymers or composites.

FIG. 10G illustrates a further variation of a conductive plate 224 in which an annular redesigned pocket shaped riser or podium is shown at 226 incorporated into the underside of the plate. The pocket may be filled with a suitable conductive material and is further configured with a plurality of coaxial ring shaped recesses 228, 230, 232 and 234. The examples of FIGS. 10D-10H each also further provide the aspects of lower magnetic friction patterns, in combination with controlled magnetic flux overflow onto the surface of the plates.

A further subset of cooktop or surface heating conductive plates are shown in each of FIGS. 10H-10K, in each instance providing a reconfiguration for integrating or attaching vertical magnets. FIG. 10H depicts a plate 236 having a single downward projection 236, which can further integrate any arrangement of magnets/electromagnets. FIG. 10I provides a similar conductive plate construction 240 in which dual annular downward projections 242 and 244 can mount any desired arrangement of magnets/electromagnets. FIGS. 10J and 10K further reference, respectively at 246 and 248, additional variants of conductive plates similar to those previously shown and which can vary as to any of thickness and/or material composition.

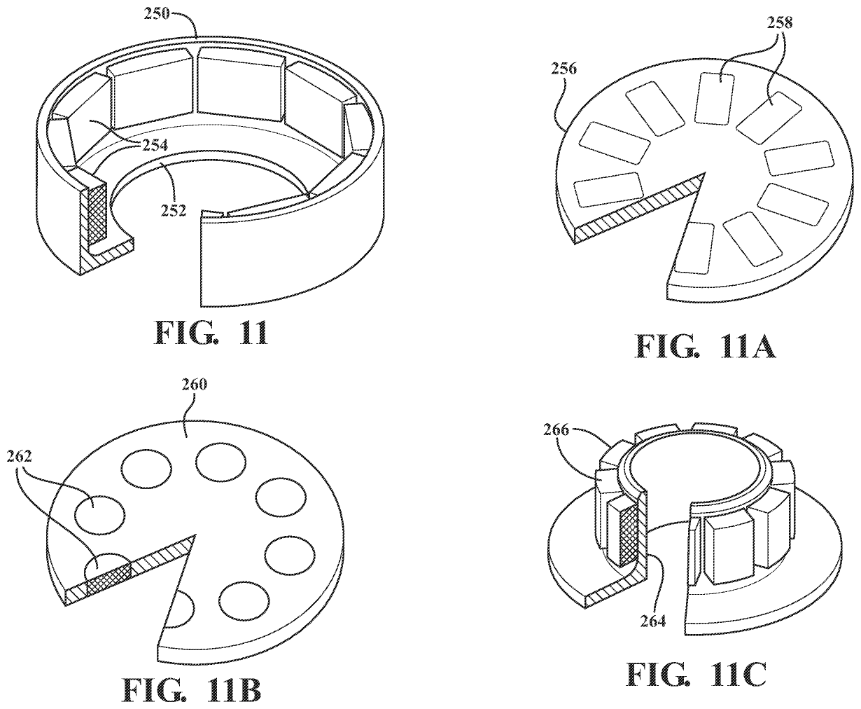

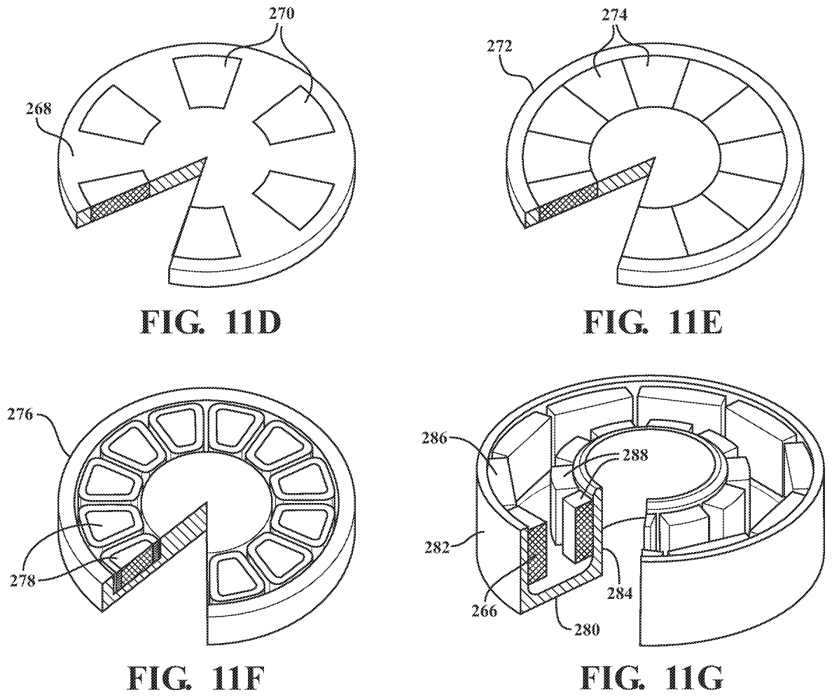

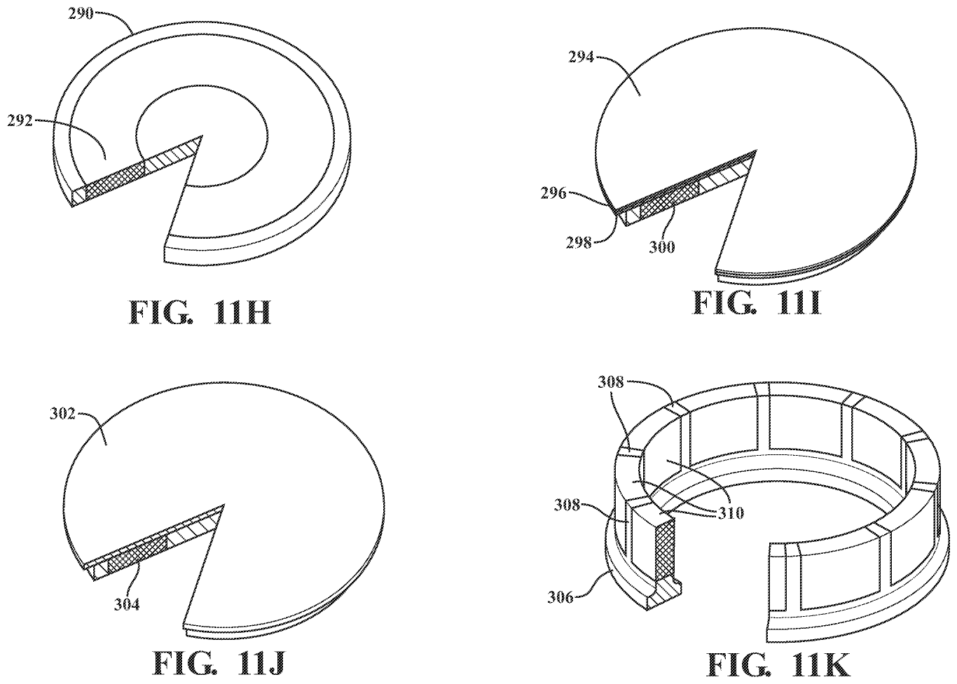

FIGS. 11-11K provide a series of illustrations of varying magnetic or electromagnetic plate, pan or ring configurations according to other variants the present inventions. FIG. 11 depicts a circular pan shaped construction 250 including a central cutout 252 location, in combination with an inwardly facing circumferential array 254 of magnets/electromagnets supported upon the inside facing surface of the annular sidewall of the pan.

FIG. 11A exhibits a thickened circular disk shape 256 (again shown in pie shaped cutaway) and which can include any insulating matrix supporting material, within which is incorporated a plurality of magnets/electromagnets shown at 258 having a generally rectangular shape. FIG. 11B presents a similar plate configuration 260 incorporating any type of magnet/electromagnet array in the shape of circular disc/cylinder magnets/electromagnets 262 positioned in a circumferential array.

FIG. 11C illustrates a further reconfiguration of a plate 264 having an outward facing “L” shape in cross section and so that an outward facing annular array of inner vertical magnets 266 are supported thereupon.

FIG. 11D depicts a ring shaped variant of the magnet/electromagnet plate, at 268, upon which are positioned (or integrated) an outward facing array of magnets/electromagnets 270. The circular disk shaped plate can again include any insulating material seating the plurality of magnets/electromagnets 270 which are further depicted having a circumferentially spaced apart and individual trapezoidal shaped segment magnets.

FIG. 11E presents a disk shaped plate 272 in which the magnet/electromagnet array is redesigned so that the individual portions (again shown as trapezoidal shaped at 274) are interconnected along opposite side edges in order to form a continuous array around the intermediate circumference of the body.

FIG. 11F depicts a further plate configuration 276 incorporating an array of electromagnets 278 seated within an annular upper facing pocket. FIG. 11G is a variant of the circular pan construction of FIG. 11 which includes a ring shaped body 280 with outer 282 and inner 284 spaced apart walls, these respectively supporting each of an outer row of inwardly facing vertical magnets 286 along with an inner row of outwardly facing vertical magnets 288. As shown, the inner row of magnets 288 can be smaller to accommodate the reduced supporting circumference of the inner spaced wall 284.

FIG. 11H depicts a further plate 290 integrating a solid multi-polarity ring 292. FIG. 11I further discloses a yet further plate 294 which includes a combination of multi-layers (see at 296 and 298) for providing any combination of deflecting, flux shielding and isolating materials. Also shown is a magnet/electromagnet 300 (single or plural arrayed) which is positioned underneath the multi-layers.

FIG. 11J depicts, at 302, another plate construction having a single layer of a deflecting, flux shielding, and/or isolating material, this again in combination with a similar magnet/electromagnet 304. FIG. 11K depicts a yet further variant of plate with a ring shaped base 306 exhibiting a circumferential spaced arrays of upward pillar supports 308, between which are alternated and seated a single center row of magnets/electromagnets 310 to define a simplified annular array.

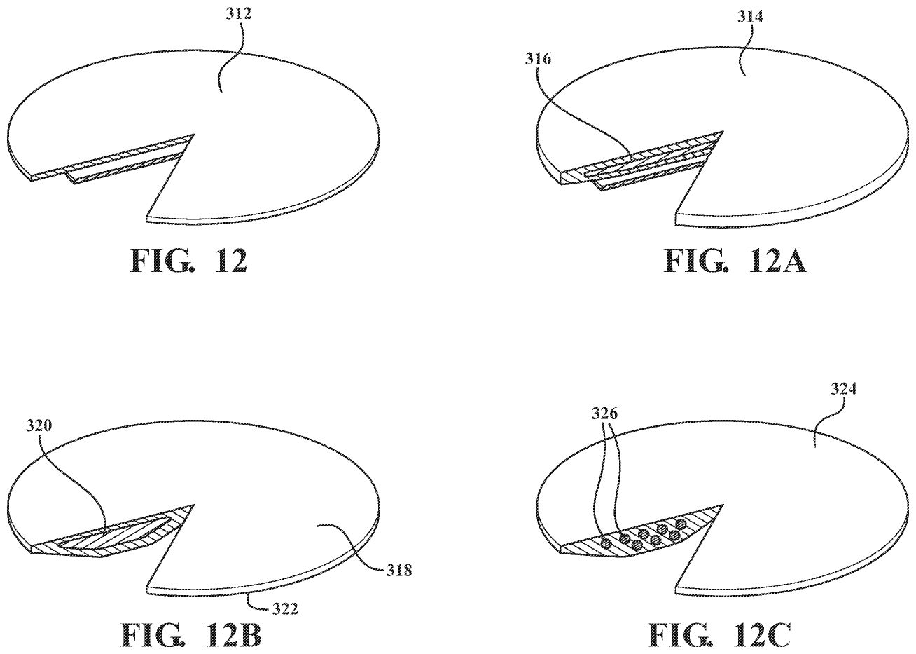

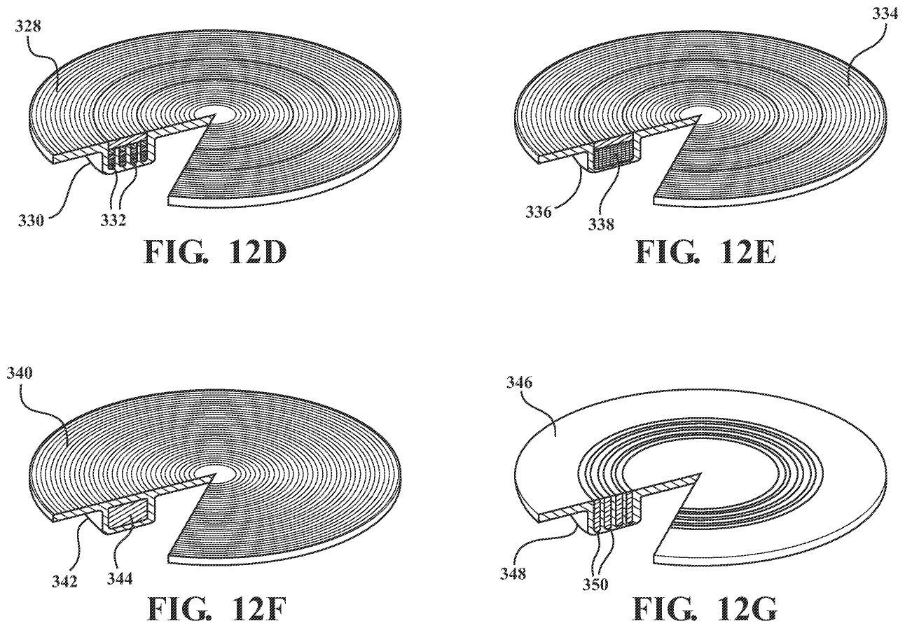

Proceeding now to FIGS. 12-12G, depicted are varying examples of conductive plate configurations of different materials and which can include any combination of varying compositions including one or more of coating, magnetic flux shielding, magnetic permeable materials, conductive materials and/or insulating materials. FIG. 12 depicts a first example of a thin disk shaped conductive plate 312 (this as understood being provided in combination with an underside positioned magnet/electromagnet supporting plate), with a second configuration 314 being shown in FIG. 12A and having a thickened and outer tapered profile as shown in cutaway. A magnetic flux shield or other conductive material layer or plate insert with different magnetic permeability is shown at 316 in cutaway incorporated into an interior of the plate configuration 314.

FIG. 12B depicts a conductive plate design 318 similar to that shown at 314, the plate integrating a varied flux shield or other conductive material layer with different magnetic permeability (at 320) according to a different configuration to that shown FIG. 12A. The insert 320 is understood to include any different polygonal shape.

As further shown in each of FIGS. 12-12C, the plate configurations each can further include an underside inner diameter support, and this is best depicted at 322 in FIG. 11B. FIG. 12C depicts a conductive plate 324 similar to that shown in FIG. 12B and in which the magnetic flux or conductive material is reconfigured as shown at 326 in the form of individual spaced and embedded wire or cylindrical shaped elements, and which can be formed according to any interior array or pattern.

FIGS. 12D-12G provide additional examples of conductive plate constructions which are similar to those previously described in FIGS. 10D-10G, and which can include any magnetic permeable or conductive material contained within the individual underside configured pockets (or continuous annular pocket). Conductive plate 328 in FIG. 11D generally corresponds to that shown at 216 in FIG. 10D and includes a coaxial etched or ribbed upper surface in combination with the underside pocket 330 being filled with a suitable magnetic permeable or conductive material, see as shown at 332. Related conductive plate 334 is shown in FIG. 12E and includes an underside pocket 336 incorporating a variation of a suitable material. As further described, this can include any loose filled random or ordered material 338.

FIG. 12F depicts a further disk-shaped conductive plate 340, again including an underside located pocket (singular or plural spaced) 342 and again filled with a suitable material 344. Finally, FIG. 12G depicts a plate 346 which corresponds with that shown in FIG. 10G and which again includes an annular redesigned pocket 348 incorporated into the underside of the plate. The pocket again is filled with a suitable material, this being shown at 350 and being further configured within the plurality of coaxial ring shaped recesses, similar to as previously described and referenced at 228, 230, 232 and 234 in FIG. 10G.

In each instance, the arrangement and composition of the materials provided within the conductive plates can include any suitable coatings, magnetic flux shielding or magnetic permeable materials, as well as any desired arrangement of either conductive or insulating materials. In this manner, the examples depicted are intended to be exemplary only and an unlimited number of additional designs are envisioned.

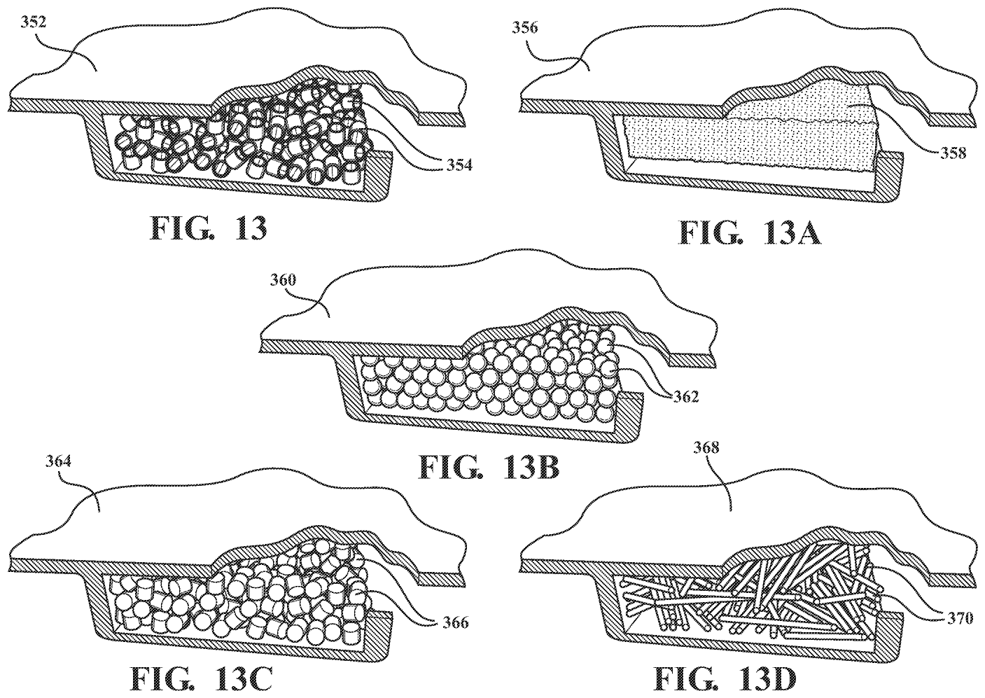

Proceeding to FIGS. 13-13D, depicted are variations of cooktop located conductive plate pockets, in each instance forming a part of the conductive plate such as previously described, and which are filled with different types of materials and configurations of packed beds, these including without limitation patterns of materials, bi-materials or multi-materials designs, such materials including any of metals or alloys, ceramics or any metal ceramic composite, graphite, polymers or composites or any combination of such materials. FIG. 13 depicts a first pocket 352, such as again understood to form part of and be incorporated into a conductive plate, such as not limited to any of those previously shown. A plurality of loose filled hollow or sleeve shaped elements 354 are depicted and which fill the interior bed of the pocket, the canisters again not being limited to any arrangement or composition which can include one or more types of metal, ceramics, polymers or composites.

FIG. 13A depicts a further version of a pocket 356 in which the inner bed or interior is filled with a loose fill granulate material 358, again selected from any of the above. FIG. 13B similarly shows a pocket 360 including a fill material exhibiting a ball or pellet shape (at 362). FIG. 13C depicts a pocket 364 in which the fill material is in the form of solid canister portions 366. FIG. 13D depicts another version of a conductive plate defined pocket 368 in which a plurality of loose or random filled stem shaped portions 370 are contained within pocket.

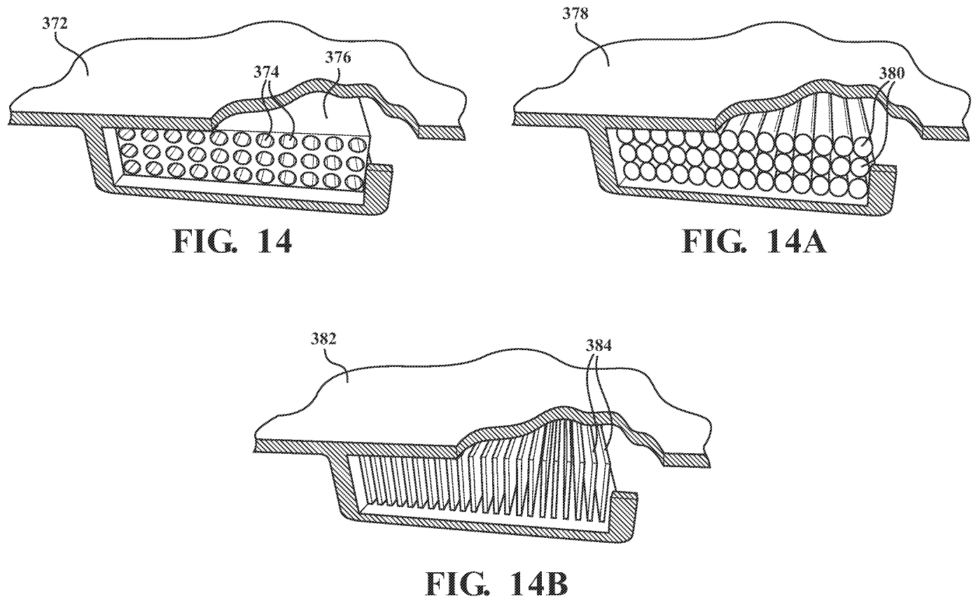

Finally, FIGS. 14-14B depict additional configurations of cooktop located conductive plate pockets, in each instance being filled with various ordered structures (as opposed to filled packed beds as in FIGS. 13-13D), and which can again include patterns of materials, bi-materials or multi-materials designs, such materials including any of metals or alloys, ceramics or any metal ceramic composite, graphite, polymers or composites or any combination of such materials. FIG. 14 provides a first example of a pocket 372, which can again be integrated into a cooktop surface located conductive plate, and which exhibits an ordered array of elongated cylinder shape elements 374 which are in turn encased within an outer matrix composition 376 so that individual members are incrementally spaced apart.

FIG. 14A depicts a similar pocket shaped construction 378 in which the elongated cylinder shaped elements, depicted at 380, are again orderly arranged in an inter-contacting parallel fashion without the need for an encasing binder. This can include utilizing either a tight packing or adhesive arrangement for achieving the orderly arrangement of the elements 380.

FIG. 14B depicts a still further arrangement of a pocket 382 in which a plurality of elongated and thin rectangular strip shaped elements 384 are orderly arranged in a closely spaced apart fashion. As previously described, the orderly arranged fill materials again can include any patterns of materials, bi-materials or multi-materials designs, such materials again including any of metals or alloys, ceramics or any metal ceramic composite, graphite, polymers or composites or any combinations of such materials and, in this instance, can further include alternating the composition of succeeding strips 384, as well as potentially incorporating multiple and varying materials into each strip 384.

As previously described, other and additional envisioned applications can include adapting the present technology for use in magnetocaloric heat pump (MHG) applications, such utilizing a magnetocaloric effect (MCE) provide either of heating or cooling properties resulting from the magnetization (heat) or demagnetization (cold) cycles. The goal in such applications is to achieve a coefficient of performance (defined as a ratio of useful heating or cooling provided to work required) which is greater than 1.0. In such an application, the system operates to convert work to heat as well as additionally pumping heat from a heat source to where the heat is required (and factoring in all power consuming auxiliaries). As is further known in the relevant technical art, increasing the COP (such as potentially to a range of 2.0-3.5 or upwards) further results in significantly reduced operating costs in relation to the relatively small input electrical cost required for rotating the conductive plate(s) relative to the magnetic plate(s). Magnetic refrigeration techniques result in a cooling technology based on the magnetocaloric effect and which can be used to attain extremely low temperatures within ranges used in common refrigerators, such as without limitation in order to reconfigure the present system as a fluid chiller, air cooler, active magnetic regenerator or air conditioner.

As is further known in the relevant technical art, the magnetocaloric effect is a magneto-thermodynamic phenomenon in which a temperature change of a suitable material is again caused by exposing the material to a changing magnetic field, such being further known by low temperature physicists as adiabatic (defined as occurring without gain or loss of heat) demagnetization. In that part of the refrigeration process, a decrease in the strength of an externally applied magnetic field allows the magnetic domains of a magnetocaloric material to become disoriented from the magnetic field by the agitating action of the thermal energy (phonons) present in the material.

If the material is isolated so that no energy is allowed to (re)migrate into the material during this time, (i.e., again the adiabatic process) the temperature drops as the domains absorb the thermal energy to perform their reorientation. The randomization of the domains occurs in a similar fashion to the randomization at the Curie temperature of a ferromagnetic, ferrimagnetic, antiferromagnetic, paramagnetic or diamagnetic material, except that magnetic dipoles overcome a decreasing external magnetic field while energy remains constant, instead of magnetic domains being disrupted from internal ferromagnetism, ferrimagnetism, antiferromagnetism, (or either of paramagnetism/diamagnetism) as energy is added. Applications of this technology can include, in one non-limited application, the ability to heat a suitable alloy arranged inside of a magnetic field as is known in the relevant technical art, causing it to lose thermal energy to the surrounding environment which then exits the field cooler than when it entered.

Other envisioned applications include the ability to generate heat for conditioning any fluid (not limited to water) utilizing either individually or in combination rare earth magnets placed into an oscillating magnetic field at a given frequency as well as static electromagnetic field source systems including such as energized electromagnet assemblies which, in specific instances, can be combined together within a suitable assembly not limited to that described and illustrated herein and for any type of electric induction, electromagnetic and magnetic induction or magnetocaloric application. It is further envisioned that the present assembly can be applied to any material which is magnetized, such including any of diamagnetic, paramagnetic, and ferromagnetic, ferrimagnetic or antiferromagnetic materials without exemption also referred to as magnetocaloric materials (MEMs).

Additional factors include the ability to reconfigure the assembly so that the frictionally heated fluid existing between the overlapping rotating magnetic and stationary fluid communicating conductive plates may also include the provision of additional fluid mediums (both gaseous and liquid state) for better converting the heat or cooling configurations disclosed herein. Other envisioned applications can include the provision of capacitive and resistance (ohmic power loss) designs applicable to all materials/different configurations as disclosed herein.

The present invention also envisions, in addition to the assembly as shown and described, the provision of any suitable programmable or software support mechanism, such as including a variety of operational modes. Such can include an Energy Efficiency Mode: step threshold function at highest COP (at establish motor or other rotary inducting input rpm) vs Progressive Control Mode: ramp-up curve at different rpm/COPs).

Other heating/cooling adjustment variables can involve modifying the degree of magnetic friction created, such as by varying the distance between the conductive fluid circulating disk packages and alternating arranged magnetic/electromagnetic plates. A further variable can include limiting the exposure of the conductive fluid (gas, liquid, etc.,) to the conductive component/linearly spaced disk packages, such that a no flow condition may result in raising the temperature (and which can be controllable for certain periods of time).

As is further generally understood in the technical art, temperature is limited to Curie temperature, with magnetic properties associated with losses above this temperature. Accordingly, rare earth magnets, including such as neodymium magnets, can achieve temperature ranges upwards of 900° C. to 1000° C.

Ferromagnetic, ferrimagnetic, antiferromagnetic, paramagnetic or diamagnetic materials, such as again which can be integrated into the conductive plates, can include any of Iron (Fe) having a Curie temperature of 1043K (degrees Kelvin), Cobalt (Co) having a Curie temperature of 1400K, Nickel (Ni) having a Curie temperatures of 627K and Gadolinium (Gd) having a Curie temperature of 292K.

According to these teachings, Curie point, also called Curie Temperature, defines a temperature at which certain magnetic materials undergo a sharp change in their magnetic properties. In the case of rocks and minerals, remanent magnetism appears below the Curie point—about 570° C. (1,060° F.) for the common magnetic mineral magnetite. Below the Curie point—by non-limiting example, 770° C. (1,418° F.) for iron—atoms that behave as tiny magnets spontaneously align themselves in certain magnetic materials.

In ferromagnetic materials, such as pure iron, the atomic magnets are oriented within each microscopic region (domain) in the same direction, so that their magnetic fields reinforce each other. In antiferromagnetic materials, atomic magnets alternate in opposite directions, so that their magnetic fields cancel each other. In ferrimagnetic materials, the spontaneous arrangement is a combination of both patterns, usually involving two different magnetic atoms, so that only partial reinforcement of magnetic fields occurs.

Given the above, raising the temperature to the Curie point for any of the materials in these three classes entirely disrupts the various spontaneous arrangements, and only a weak kind of more general magnetic behavior, called paramagnetism, remains. As is further known, one of the highest Curie points is 1,121° C. (2,050° F.) for cobalt. Temperature increases above the Curie point produce roughly similar patterns of decreasing paramagnetism in all three classes of materials such that, when these materials are cooled below their Curie points, magnetic atoms spontaneously realign so that the ferromagnetism, antiferromagnetism, or ferrimagnetism revives. As is further known, the antiferromagnetic Curie point is also referenced as the Neel temperature.

Other factors or variable controlling the temperature output can include the strength of the magnets/electromagnets which are incorporated into the magnet/electromagnet carrier or magnetic plates, such as again by selected rare earth magnets having varying properties or, alternatively, by adjusting the factors associated with the use of electromagnets including an amount of current through the coils, adjusting the core ferromagnetic properties (again though material selection) or by adjusting the cold winding density around the associated core.

Other temperature adjustment variables can include modifying the size, number, location and orientation of the assemblies (elongated and plural magnet/electromagnet and alternative conductive plates). Multiple units or assemblies can also be stacked, tiered or otherwise ganged in order to multiply a given volume of conditioned fluid which is produced.

Additional variables can include varying the designing of the conductive disk packages, such as not limited varying a thickness, positioning or configuration of a blade or other fluid flow redirecting profile integrated into the conductive plates, as well as utilizing the varying material properties associated with different metals or alloys, such including ferromagnetic, ferrimagnetic, antiferromagnetic, paramagnetic and diamagnetic properties.

Having described my invention, other and additional preferred embodiments will become apparent to those skilled in the art to which it pertains, and without deviating from the scope of the appended claims. The detailed description and drawings are further understood to be supportive of the disclosure, the scope of which being defined by the claims. While some of the best modes and other embodiments for carrying out the claimed teachings have been described in detail, various alternative designs and embodiments exist for practicing the disclosure defined in the appended claims.

The foregoing disclosure is further understood as not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, a person of ordinary skill in the art will recognize that changes may be made in form and detail without departing from the scope of the present disclosure. Thus, the present disclosure is limited only by the claims.

In the foregoing specification, the disclosure has been described with reference to specific embodiments. However, as one skilled in the art will appreciate, various embodiments disclosed herein can be modified or otherwise implemented in various other ways without departing from the spirit and scope of the disclosure. Accordingly, this description is to be considered as illustrative and is for the purpose of teaching those skilled in the art the manner of making and using various embodiments of the disclosure. It is to be understood that the forms of disclosure herein shown and described are to be taken as representative embodiments. Equivalent elements, materials, processes or steps may be substituted for those representatively illustrated and described herein. Moreover, certain features of the disclosure may be utilized independently of the use of other features, all as would be apparent to one skilled in the art after having the benefit of this description of the disclosure. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

Further, various embodiments disclosed herein are to be taken in the illustrative and explanatory sense, and should in no way be construed as limiting of the present disclosure. All joinder references (e.g., attached, affixed, coupled, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other.

Additionally, all numerical terms, such as, but not limited to, “first”, “second”, “third”, “primary”, “secondary”, “main” or any other ordinary and/or numerical terms, should also be taken only as identifiers, to assist the reader's understanding of the various elements, embodiments, variations and/or modifications of the present disclosure, and may not create any limitations, particularly as to the order, or preference, of any element, embodiment, variation and/or modification relative to, or over, another element, embodiment, variation and/or modification.

It will also be appreciated that one or more of the elements depicted in the drawings/figures can also be implemented in a more separated or integrated manner, or even removed or rendered as inoperable in certain cases, as is useful in accordance with a particular application. Additionally, any signal hatches in the drawings/figures should be considered only as exemplary, and not limiting, unless otherwise specifically specified.

I claim:

1. An assembly for magnetic induction or magnetocaloric heating of a cooktop surface, comprising:
a housing supporting the cooktop surface and having each of a flow inlet and a flow outlet;
a magnetocaloric heating material conductive plate incorporated into the cooktop surface; and
one or more magnets or electromagnets rotatable in underside proximity to said magnetocaloric heating material conductive plate, resulting in Joule heating and eddy currents being generated through oscillating of magnetic fields at a given frequency, and which are conducted through said magnetocaloric heating material conductive plate and emanating from the cooktop surface.

2. The assembly as described in claim 1, further comprising a heat insulating material surrounding said conductive plate.

3. The assembly as described in claim 1, said housing further comprising a sealed interior containing a volume of any type of thermal fluid oil, lubricant, refrigerant or any other fluid with high specific heat capacity and high boiling point providing any heat transfer properties.

4. The assembly as described in claim 2, the cooktop surface further comprising a material overlaying said heat insulating material, apertures in said material seating an outer annular edge of said conductive material.

5. The assembly as described in claim 1, said flow inlet further comprising a plurality of intake openings configured along an underside of said housing.

6. The assembly as described in claim 5, further comprising a motor or other rotary inducing input supported within said housing, a shaft extending from said motor or other rotary inducing input to a carrier disk embedding or holding said magnets or electromagnets.

7. The assembly as described in claim 6, said magnets or electromagnets further comprising a ring shape.

8. The assembly as described in claim 6, said magnets or electromagnets further comprising a plurality of individual and circumferentially spaced segments arranged about a perimeter of said disk.

9. The assembly as described in claim 6, said motor or other rotary inducing input further comprising an outer casing, a plurality of pass-through apertures configured through said casing in communication with said intake openings.

10. The assembly as described in claim 9, further comprising a skirt secured to an underside of said rotatable disk for redirecting fluid flow radially outwardly and downwardly through an outer annular underside configuration of said fluid outlet defined in said housing.

11. The assembly as described in claim 1, further comprising one or more conventional heating elements integrated into the magnetocaloric cooktop material for assisting initial heating of said magnetocaloric heating material conductive plate.

12. The assembly of claim 11, said conventional heating elements further comprising a resistor coil.

13. The assembly of claim 11, further comprising a controller for deactivating said conventional element after upon inductive heating of said magnetocaloric heating material conductive plate.

14. The assembly as described in claim 1, said magnetocaloric heating material conductive plate further comprising any of a metal or alloy, ceramic, metal-ceramic composite material, polymer, other composite, graphite or combination thereof.

15. The assembly as described in claim 1, said magnetocaloric heating material conductive plate and said magnets/electromagnets each further comprising a plurality of individual subassemblies distributed across the cooktop surface.

16. The assembly as described in claim 1, said magnetocaloric heating material conductive plate further comprising a conductive plate further incorporating a variety of conductive materials including any of a metal or alloy, ceramic, metal-ceramic composite material, polymer, other composite, graphite or combination thereof.

17. The assembly as described in claim 16, said conductive plate further comprising one or more pockets containing said conductive or magnetic permeable materials in either of packed beds or orderly filled manner.

18. The assembly as described in claim 16, said conductive plates further comprising any of surface ribs, etching or recessing in proximity to the cooktop surface.

19. An assembly for inductive heating of a cooktop surface, comprising:
a housing supporting the cooktop surface;
a magnetocaloric heating material conductive plate incorporated into the cooktop surface;
a heat insulating material surrounding said magnetocaloric heating material conductive plate;
a glass overlaying said heat insulating material, apertures in said glass seating an outer annular edge of said magnetocaloric heating material conductive plate;
ventilation intake openings configured along an underside of said housing;
an induction control assembly incorporated into said housing interior underneath said magnetocaloric heating material conductive plate; and
an arrangement of induction coils in underside proximity to said magnetocaloric heating material conductive plate which, upon said control assembly passing a current through, causing creation of high frequency oscillating magnetic fields resulting in eddy currents through said magnetocaloric heating material conductive plate and emanating from the cooktop surface.

20. The assembly as described in claim 19, said inner housing further comprising any of a metal, metal alloy, ceramic, metal-ceramic composite, polymer, polymer composite, graphite or combination of such materials.

21. The assembly as described in claim 20, said magnetocaloric material further comprising a conductive plate having one or more pockets containing said conductive materials in either of packed beds or orderly filled manner.
